(19) United States
(12) Patent Application Publication
(10) Pub. No.: US 2013/0261933 A1
(43) Pub. Date: Oct. 3, 2013

(54) METHOD FOR THE INJECTION COMPUTATION FOR AN INTERNAL COMBUSTION ENGINE

(71) Applicant: Martin HUBER, Marbach Am Neckar (DE)

(72) Inventor: Martin HUBER, Marbach Am Neckar (DE)

(73) Assignee: ROBERT BOSCH GMBH, Stuttgart (DE)

(21) Appl. No.: 13/852,248

(22) Filed: Mar. 28, 2013

(30) Foreign Application Priority Data
Mar. 28, 2012 (DE) 10 2012 204 975.4

(51) Int. Cl. F02D 41/30

(52) U.S. Cl. CPC F02D 41/30
USPC 701/103; 123/478

(57) ABSTRACT

A method for the injection computation for an internal combustion engine, in particular for a gasoline range extender engine. This includes ascertaining an adaptation factor, which represents fuel aging, from a model of the fuel and a fuel outgassing via a tank vent and adaptation of a fuel injection quantity and/or a fuel injection time using the adaptation factor.

### CROSS REFERENCE

The present application claims the benefit under 35 USC §119 of German Patent Application No. DE 102012204975.4 filed on Mar. 28, 2012, which is expressly incorporated herein by reference in its entirety.

### FIELD

The present invention relates to a method for the injection computation for an internal combustion engine, in particular for a gasoline range extender engine. In addition, the present invention relates to a computer program which executes all the steps of the method according to the present invention when it is running on a computer. Finally, the present invention relates to a computer program product having program code stored on a machine-readable carrier, for carrying out the method according to the present invention when the program is executed on a computer.

### BACKGROUND INFORMATION

Motor vehicles driven by an electric motor are increasingly being developed and manufactured by the automotive industry. The electrical power for operating the electric motor for driving the electric vehicle is obtained from a battery situated in the electric vehicle. The battery is charged on an electrical power grid while the electric vehicle is parked. The electric vehicle has a battery charger for this purpose. The capacity for storing electrical power in the battery is limited here, so that only cruising ranges of approximately 50 kilometers to 200 kilometers are reachable by the electric vehicle.

To increase the cruising range of an electric vehicle, it is often equipped with a so-called range extender. This is an internal combustion engine generator unit. For longer driving distances of an electric vehicle, during which the battery cannot be charged adequately or at all from a power grid, the battery is charged with the aid of the internal combustion engine generator unit and/or electrical power is supplied to the electric motor with the aid of the internal combustion engine generator unit. The possible cruising range of such an electric vehicle having a range extender may therefore be increased to distances of approximately 600 kilometers, corresponding to a cruising range of traditional motor vehicles driven exclusively by an internal combustion engine.

However, the goal is to utilize the internal combustion engine as little as possible to thereby minimize fuel consumption. It may absolutely happen that the internal combustion engine is not used for several months or is turned on only sporadically. During this period of time, the fuel in the tank will outgas and undergo aging. Aging of fuel has effects on the combustion performance of the internal combustion engine. Problems may therefore occur in particular when starting the internal combustion engine and misfiring may occur during operation.

### SUMMARY

An example method according to the present invention for the injection computation for an internal combustion engine, in particular for a gasoline range extender engine, includes ascertaining an adaptation factor which represents fuel aging.

The adaptation factor is ascertained from a model of the fuel and fuel outgassing through a tank vent. In addition, the method includes the adaptation of a fuel injection quantity and/or a fuel injection time using the adaptation factor. Reliable starting of the internal combustion engine and operation of the internal combustion engine without misfiring are ensured by taking into account the adaptation factor in computing the injection quantity and/or the injection time.

The model of the fuel uses as the input variables in particular a fuel tank filling level, a fuel mass consumed, a tanked fuel mass, a tank filling time and an influencing factor for taking into account a fluctuation in temperature over time. The age of the fuel may be ascertained on the basis of the fuel mass in the tank and the tank filling time. When refilling the tank with fuel, a new fuel factor representing fuel aging is preferably formed from the fuel mass added to the fuel tank during refilling in relation to the fuel mass still in the tank. In addition, this preferably also takes into account how often and how much the fuel in the tank has been heated during its time in the tank. Fuel ages less rapidly at very low temperatures than at very high temperatures.

Fuel outgassing is computed in particular from the ambient temperature and a fuel mass released via tank venting. Fuel tends to outgas at a greater rate at higher ambient temperatures.

The adaptation factor may be modeled, for example, on the basis of the fuel model or a fuel factor generated from the fuel model and the fuel outgassing on the basis of the data input of an engine characteristics map. This adaptation factor is not expressed in units and may be included in the mixture control of an internal combustion engine by multiplication. The adaptation factor of unaged fuel has a value of 1. The older the fuel and the greater the outgassing through the tank vent, the greater the adaptation factor becomes. The original injection quantity is increased by this value. If the adaptation factor is used for shifting the injection time, then it is shifted by an offset. Generally, injection may be performed somewhat earlier here because the aged mixture is not dispersed very well because it lacks volatile components.

When the internal combustion engine is an intake manifold injector in particular, it is preferable for the temperature of the internal combustion engine to be taken into account in ascertaining the adaptation factor. In addition, in ascertaining the adaptation factor, it is preferable for the temperature of the air drawn in through an intake manifold by an internal combustion engine to be taken into account. This takes into account the fact that fuel is not dispersed as well at a low temperature and will also condense on the wall of the intake manifold.

An example computer program according to the present invention, which executes all the steps of the method according to the present invention when it is running on a computer, makes it possible to implement the method according to the present invention in an existing internal combustion engine without having to make any structural changes in the engine. The computer program product according to the present invention having program code stored on a machine-readable carrier for carrying out the method according to the present invention when the program is executed on a computer or a control unit is therefore used for this purpose.

### BRIEF DESCRIPTION OF THE DRAWING

An exemplary embodiment of the present invention is illustrated in the FIGURE and explained in greater detail below.

FIG. 1 shows a flow chart for ascertaining an adaptation factor in a method according to one specific embodiment of the present invention.

### DETAILED DESCRIPTION OF EXAMPLE EMBODIMENTS

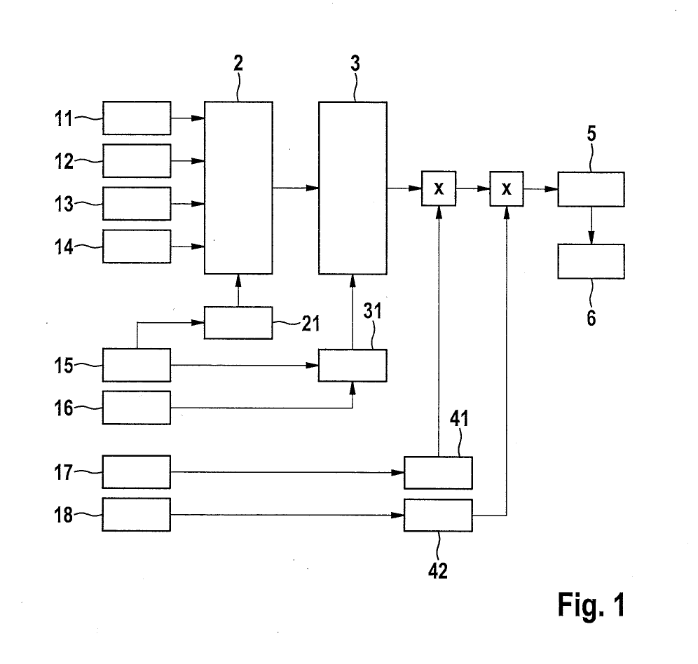

FIG. 1 schematically shows the sequence of a method for the injection computation for a gasoline range extender engine having an intake manifold gasoline injection according to one specific embodiment of the present invention. With the aid of a tank filling level sensor, a fuel tank filling level 11, a consumed fuel mass 12 and a tanked fuel mass 13 are ascertained. These variables are used together with a tank filling time 14 as input variables for a fuel model 2. An influencing factor 21 for taking into account a temperature fluctuation over time is ascertained from ambient temperature 15 and is used as an input variable for fuel model 2. Fuel model 2 and fuel outgassing 31 are used as input variables for a model for fuel aging 3. Fuel aging 3 is computed from ambient temperature 15 and a fuel mass 16 released through a tank vent. The model of fuel aging 3 outputs a dimensionless factor of fuel aging which is multiplied by a dimensionless factor of internal combustion engine temperature 41, which is ascertained from the temperature of internal combustion engine 17. In addition, a multiplication takes place by a dimensionless factor of intake air 42, which is ascertained from the temperature of air 18 drawn in by the internal combustion engine through an intake manifold. The multiplication by these three factors results in an adaptation factor 5. This adaptation factor 5 has a value of 1 for unaged fuel, and increases to a value of 1.1 with outgassing through the tank vent, for example.

The fuel injection quantity of the range extender is adapted by multiplying it by this adaptation factor 5. Alternatively, the fuel injection time is shifted to an earlier injection by an offset depending on this adaptation factor 5. More reliable starting of the range extender engine may be ensured by the example method according to the present invention. Combustion misfiring or worsening of the exhaust gas values may be prevented by using this example method.

What is claimed is:

1. A method for injection computation for an internal combustion engine, comprising:
ascertaining an adaptation factor, which represents aging of fuel, from a model of the fuel and from fuel outgassing via a tank vent; and
adapting, using the adaptation factor, at least one of a fuel injection quantity and a fuel injection time.

2. The method as recited in claim 1, wherein the model of the fuel uses as input variables a fuel tank filling level, a consumed fuel mass, a tanked fuel mass, a tank filling time and an influencing factor for taking into account a temperature fluctuation over time.

3. The method as recited in claim 1, wherein the fuel outgassing is determined from an ambient temperature and from a fuel mass released through the tank vent.

4. The method as recited in claim 1, wherein a temperature of the internal combustion engine is taken into account in ascertaining the adaptation factor.

5. The method as recited in claim 1, wherein a temperature of air drawn in through an intake manifold by the internal combustion engine is taken into account in ascertaining the adaptation factor.

6. A computer readable medium storing a computer program for injection computation for an internal combustion engine, the computer program, when executed by a processor, causing the processor to perform the steps of:
ascertaining an adaptation factor, which represents aging of fuel, from a model of the fuel and from fuel outgassing via a tank vent; and
adapting, using the adaptation factor, at least one of a fuel injection quantity and a fuel injection time.

7. A control unit configured to control a fuel injector of an internal combustion engine, the control unit configured to ascertain an adaptation factor, which represents aging of fuel, from a model of the fuel and from fuel outgassing via a tank vent, and to adapt, using the adaptation factor, at least one of a fuel injection quantity and a fuel injection time.
